(19) United States
(12) Patent Application Publication
(10) Pub. No.: US 2012/0073674 A1
(43) Pub. Date: Mar. 29, 2012

(54) GAS SUPPLY SYSTEM

(76) Inventors: Andrew Richard Thomas TATAREK, Aldershot (GB); Thomas Bickford Holbeche, Church Crookham (GB); John Norris Mitchell, Goffs Oak (GB)

(21) Appl. No.: 13/079,896

(22) Filed: Apr. 5, 2011

(30) Foreign Application Priority Data
Apr. 16, 2010 (GB) 1006363.4

(51) Int. Cl. F16K 17/40

(52) U.S. Cl. 137/68.11

(57) ABSTRACT

A gas supply system is described comprising: a gas capsule enclosed at one end by a pierceable diaphragm; a spacer element adjacent the pierceable diaphragm, the spacer element having a channel providing access to the pierceable diaphragm; a shaft with a piercing tip; and a seal. The shaft, spacer element and seal are arranged so that when the shaft accesses the pierceable diaphragm via the channel, the shaft is caused to enter into a sealing engagement with the spacer element via the seal before the piercing tip pierces the pierceable diaphragm. In an alternative embodiment, no spacer element is provided and instead a seal is provided in a groove in a wall defining a recess at a position so that when a gas capsule is inserted into the recess, the seal enters into a sealing engagement with the gas capsule before the piercing tip of the shaft pierces the pierceable diaphragm enclosing the gas capsule.

### BACKGROUND OF THE INVENTION

The present application relates to a gas supply system.

Gases are frequently supplied in capsules where the gases are held within a cavity defined by capsule walls with the cavity being enclosed at one end by a pierceable diaphragm. When a user wishes to access the gas stored within the cavity, typically, the capsule is attached to a valve mechanism. Attaching the valve mechanism causes the diaphragm to be pierced and for gases to be released from within the cavity into the valve which can then be used to control the flow of gas from the capsule.

More specifically, in a conventional arrangement a valve for controlling the flow of gas from a capsule will normally be provided with a hollow recess for receiving the head of a gas capsule. A screw thread is then provided in the interior of the recess which is arranged to mesh with a corresponding screw thread provided on the exterior the head of the gas capsule. A shaft with a piercing tip is provided as a part of the valve with the shaft protruding in to the recess. When the screw thread is tightened this fixes the capsule to the valve and also causes the piercing tip to be brought into contact with and pierce the diaphragm and release gases from the capsule into the valve.

So that the gases from the capsule only flow into the valve, it is necessary for a seal to be formed between the capsule and the valve. Conventionally, a seal such as an O-ring is provided within the recess for this purpose. This seal is arranged within the recess so that when the screw thread is tightened bringing the head of the capsule within the recess, this compresses the O-ring (axially and or radially) thereby making a gas tight seal between the cylinder and the valve.

Problems can, however arise where low capacity gas capsules (e.g. capsules with a water capacity of 5 to 100 ml, with a typical commercial size being 21 ml) are used as it can be difficult to ensure that an adequate seal is achieved between the valve mechanism and the capsule. This is because the dimensions of the capsule and valve are reduced compared with larger capsules or cylinders and as a result the amount of torque which is achieved as a screw thread is tightened is also reduced.

Additionally, when a diaphragm is pierced and gas is released from a capsule, this has the effect of locking the screw thread in position. This is because once gas is released, in order to tighten the screw thread further, it is necessary for a user to overcome the force exerted by the pressure of gas acting against the area of the seal. With gases typically stored at pressures of approximately 200 bar this force can be large even for a modest area. In the case of small gas capsules overcoming the force exerted by escaping gas can be particularly difficult because the small dimensions of the capsule prevent users from achieving the torque necessary to overcome the force. In practice this acts to limit the extent to which a diaphragm is pierced since as soon as any piercing occurs a user is prevented from tightening the thread any further. If this occurs it may be that an insufficiently large hole is made in the diaphragm to enable gases to vent from the capsule at a desired rate, particularly when the pressure in the cylinder falls as a cylinder empties.

Further high pressure gas released from a capsule can cause injury or embolism if injected through the skin. Also when a jet of gas is released from a capsule at high pressure conservation of momentum can cause a capsule to be propelled in a vigorous fashion that could cause an injury. It is therefore desirable to protect the pierceable diaphragm from accidental piercing and ensure that a gas capsule cannot be removed from a valve until the gas inside a capsule has been safely vented.

### SUMMARY OF THE INVENTION

In view of the above an alternative design which alleviates at least some of the above is desirable.

In accordance with one aspect of the present invention there is provided a gas supply system comprising: a gas capsule enclosed at one end by a pierceable diaphragm; a spacer element adjacent the pierceable diaphragm, the spacer element having a channel providing access to the pierceable diaphragm; a shaft with a piercing tip; and a seal, wherein the shaft, spacer element and seal are arranged so that when the shaft accesses the pierceable diaphragm via the channel, the shaft is caused to enter into a sealing engagement with the spacer element via the seal before the piercing tip pierces the pierceable diaphragm.

The seal may be carried on the shaft at a position where the distance between the seal and the piercing tip is less than the length of the channel. Alternatively the seal may be provided in a recess adjacent the channel where a portion of the seal protrudes into the channel at a position spaced from the pierceable diaphragm.

A vent communicating with the channel may be provided within the spacer element adjacent the end of the channel remote from the pierceable diaphragm, the recess being provided at a position between the pierceable diaphragm and the vent.

In some embodiments the recess may be open at a surface adjacent the pierceable diaphragm and the seal may be held within the recess between the spacer element and a collar provided in the recess, the collar acting to space the seal from the pierceable diaphragm.

A further seal may be provided within a groove in the spacer element adjacent the pierceable diaphragm wherein the spacer element is in a sealing engagement with the gas capsule via the further seal. Alternatively a portion of the seal remote from the portion of the seal protruding into the channel may be in a sealing engagement with the pierceable diaphragm and the spacer element.

In some embodiments a screw thread may be provided on a portion of the exterior of the shaft remote from the piercing tip and a complementary screw thread may be provided on a portion of the interior of the channel remote from the pierceable diaphragm.

In accordance with another aspect of the present invention there is provided a gas supply system comprising: a wall defining a recess for receiving the end of a gas capsule enclosed by a pierceable diaphragm; a shaft with a piercing tip protruding into the recess; and a seal provided in the wall and protruding into the recess; wherein the seal is located at a position in the wall so that when a gas capsule is inserted into the recess, the seal enters into a sealing engagement with the gas capsule before the piercing tip of the shaft pierces the pierceable diaphragm enclosing the gas capsule.

A gas supply system may further comprise a housing defining a docking station for receiving a gas capsule; and a gas pressure control valve arranged to receive gas from a gas a capsule inserted in the docking station and pass gas to an output. A gas supply system may form part of a device for forming non-thermal plasma which includes a plasma generating cell operable to receive gas from the output and apply an electrical potential to the received gas to generate a non-thermal plasma.

In accordance with another aspect of the present invention there is provided a gas capsule comprising: a housing defining a cavity for containing gas, the cavity being enclosed at one end by a pierceable diaphragm; a spacer element adjacent the pierceable diaphragm, the spacer element having a channel providing access to the pierceable diaphragm, the channel being configured to receive a shaft terminating with a piercing tip for piercing the pierceable diaphragm, and a seal provided in a recess in the spacer element adjacent the channel, wherein the arrangement of the channel and the seal is such that when a shaft terminating with a piercing tip for piercing the pierceable diaphragm accesses the pierceable diaphragm via the channel, the shaft is caused to enter into a sealing engagement with the spacer element via the seal before the piercing tip pierces the pierceable diaphragm.

In accordance with a further aspect there is provided a gas supply apparatus comprising: a housing defining a docking station for receiving a gas capsule enclosed at one end by a pierceable diaphragm, having a spacer element adjacent the pierceable diaphragm, the spacer element having a channel providing access to the pierceable diaphragm and a seal in a recess in the spacer element adjacent the channel; and a shaft terminating in a piercing tip arranged relative to the housing so that when the docking station receives a gas capsule enclosed at one end by a pierceable diaphragm, having a spacer element adjacent the pierceable diaphragm, the spacer element having a channel providing access to the pierceable diaphragm and a seal in a recess in the spacer element adjacent the channel, the shaft is caused to access the pierceable diaphragm of the gas capsule via the channel in the spacer element of the capsule, with the shaft entering into a sealing engagement with the spacer element via the seal before the piercing tip pierces the pierceable diaphragm.

A screw thread may be provided on the exterior of the shaft remote from the piercing tip the screw thread being operable to engage a screw thread provided in the spacer element of a gas capsule received by the docking station.

In another aspect there is provided a gas supply apparatus comprising: a housing defining a docking station for receiving a gas capsule enclosed at one end by a pierceable diaphragm, having a spacer element adjacent the pierceable diaphragm, the spacer element having a channel providing access to the pierceable diaphragm; a shaft carrying a seal and terminating in a piecing tip, the shaft being arranged relative to the housing so that when the docking station receives a gas capsule having a spacer element adjacent a pierceable diaphragm, the spacer element having a channel providing access to the pierceable diaphragm, the shaft is caused to access the pierceable diaphragm of the gas capsule via the channel in the spacer element, with the shaft entering into a sealing engagement with the spacer element via the seal before the piercing tip pierces the pierceable diaphragm.

A gas supply apparatus may further comprise a gas pressure control valve arranged to receive gas from a gas a capsule inserted in the docking station and pass gas to an output.

In accordance with a further aspect there is provided a gas capsule comprising: a housing defining a cavity for containing gas, the cavity being enclosed at one end by a pierceable diaphragm; and a spacer element adjacent the pierceable diaphragm, the spacer element having a channel providing access to the pierceable diaphragm, the channel being configured to receive a shaft terminating with a piercing tip for piercing the pierceable diaphragm, wherein the channel is configured so that when a shaft terminating with a piercing tip for piercing the pierceable diaphragm carrying a seal accesses the pierceable diaphragm via the channel, the shaft is caused to enter into a sealing engagement with the spacer element via the seal before the piercing tip pierces the pierceable diaphragm.

### BRIEF DESCRIPTION OF THE DRAWINGS

Further aspects and embodiments of the present invention will become apparent with reference to the accompanying description and drawings in which:

FIG. 1 is a schematic illustration of a device for generating non-thermal plasma incorporating a gas supply system in accordance with the present application;

FIG. 2A is a cross sectional diagram of a gas supply system in accordance with a first embodiment of the present invention prior to a shaft with a piercing tip entering a channel provided in a spacer element;

FIG. 2B is a cross sectional diagram of the gas supply system of FIG. 2A illustrating a shaft with a piercing tip entering sealing engagement with a channel provided in a spacer element prior to piercing a pierceable diaphragm;

FIG. 2C is a cross sectional diagram of the gas supply system of FIG. 2A illustrating a shaft with a piercing tip piercing a pierceable diaphragm;

FIG. 2D is a cross sectional diagram of the gas supply system of FIG. 2A illustrating a shaft with a piercing tip venting subsequent to piercing a pierceable diaphragm without being fully disengaged;

FIG. 3 is a cross sectional diagram of a gas supply system in accordance with a second embodiment of the present invention;

FIG. 4 is a cross sectional diagram of a gas supply system in accordance with a third embodiment of the present invention;

FIG. 5 is a cross sectional diagram of a gas supply system in accordance with a fourth embodiment of the present invention;

FIG. 6 is a cross sectional diagram of a gas supply system in accordance with a fifth embodiment of the present invention; and

FIG. 7 is a cross sectional diagram of a gas supply system in accordance with a sixth embodiment of the present invention.

### DETAILED DESCRIPTION OF THE INVENTION

### FIRST EMBODIMENT

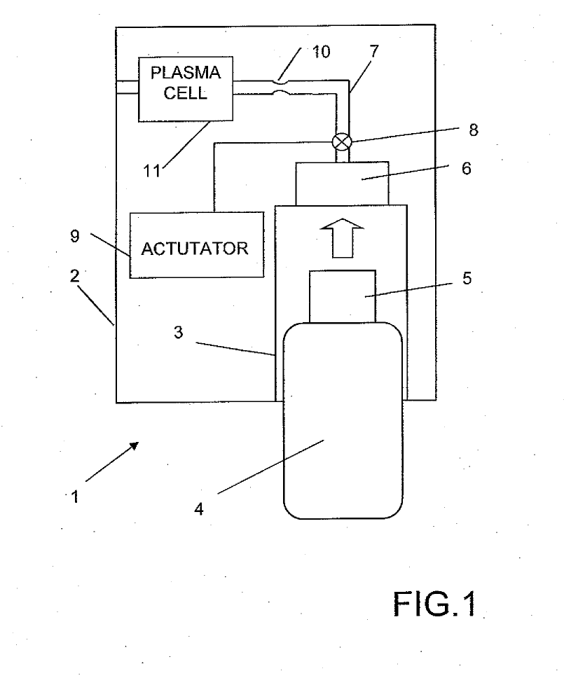

FIG. 1 is a schematic diagram of a handheld device 1 for generating non-thermal plasma comprising a housing 2 which defines a docking station 3 for receiving a gas capsule 4 when the gas capsule is inserted into the docking station in the direction indicated by the arrow.

When fully inserted into the docking station 3, the head 5 of the gas capsule 4 is arranged to interact with a recess in a gas pressure control valve 6. More specifically and as will be described in detail later, a screw thread provided on the head of the gas capsule 4 is arranged to interact with a matching screw thread provided in the recess in the control valve 6. When the head 5 of the gas capsule 4 is screwed into the recess, this causes a shaft provided within the recess to pierce a pierceable diaphragm at the top of head 5 causing gas to be released from the gas capsule 4 into the valve 6. The gas pressure control valve 6 then passes the gas released at high pressure from the gas capsule 4 at a controlled lower pressure to an output 7 having a second valve 8 controlled by an actuator 9, and a restriction 10. When activated by the actuator 9 the second valve 8 opens allowing gas to pass through the valve 8 to a plasma cell 11 via the restriction 10. The combined effect of the gas pressure control valve 6 and the restriction 10 is to cause gas to enter the plasma cell 11 at a controlled rate. When an electrical potential is applied to the gas within the plasma cell 11 a non-thermal plasma is generated. The device might carry its own power source or alternatively be connected by a suitable cable to an external power source.

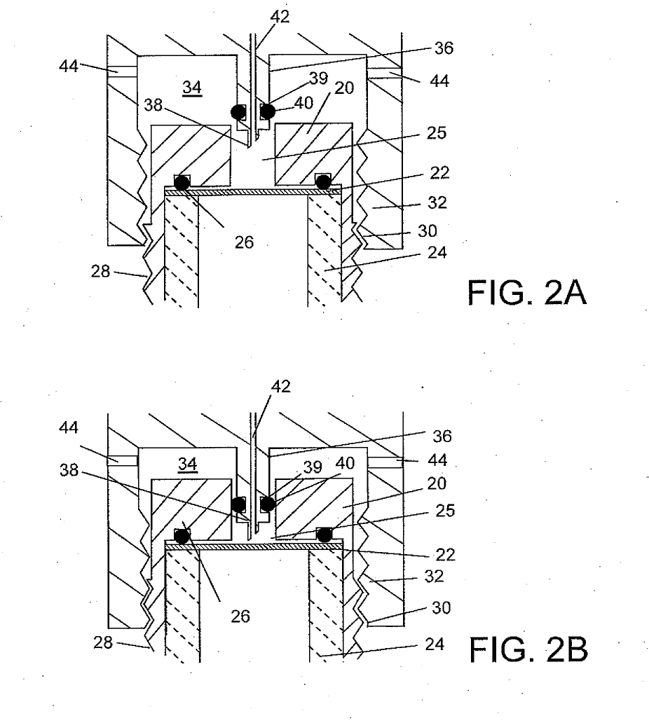

The interaction of the head 5 of a gas capsule 4 and the recess provided in the gas pressure control valve 6 will now be explained in greater detail with reference to FIGS. 2A-D which illustrate the engagement of the head 5 of a gas capsule 4 with the recess of a gas pressure control valve 6 as a gas capsule is screwed into the recess.

As is shown in FIGS. 2A-D, in this embodiment, at the head 5 of the gas capsule 4 a spacer element 20 is provided adjacent a pierceable diaphragm 22 which encloses the end of the cavity containing gas defined by the walls 24 of the gas capsule 4. The spacer element 20 acts to restrict access to the pierceable diaphragm 22 to a channel 25 provided in the centre of the spacer element 20.

The spacer element 20 has a groove adjacent the pierceable diaphragm 22 which contains o-ring 26. The attachment of the spacer element 20 to the gas capsule 24 is such to compress this o-ring 26 thereby causing the o-ring 26 act as a seal so ensure that any gases which pass through the pierceable diaphragm 22 are forced to exit via the channel 25 in the spacer element 20. The spacer element 24 can be attached to the rest of the capsule 4 via any suitable means such as being crimped or screwed to the head 5 of the gas capsule 4.

In this embodiment a screw thread 28 is provided on the exterior of the spacer element 20 which is arranged to engage with a corresponding screw thread 30 provided on the interior of a wall 32 of the valve 6 which acts to define a substantially cylindrical recess 34 for receiving the head 5 of the gas capsule 4. The diameter of the recess 34 will depend upon the size of the gas capsule 4 which is intended to be received. In the case of a typical small gas capsule, the recess 34 would have a diameter of the order of about 10 mm.

A shaft 36 which terminates in a piercing tip 38 protrudes into the centre of the recess 34. In this embodiment, the shaft 36 has a groove 39 near the piercing tip 38 which carries an o-ring 40 which protrudes slightly beyond the circumference of the shaft 36. For an embodiment for use with a small gas capsule, the shaft would have a diameter of about 5 mm. In such an embodiment the o-ring 40 carried on the recess would have a section of about 1.5 to 1.78 mm.

An axial conduit 42 is provided within the shaft 36 providing a gas pathway to the interior of the valve 6. In the case of a shaft 36 having a diameter of approximately 5 mm, the diameter of such an axial conduit 42 would be approximately 1 mm, with the walls of the shaft around the axial conduit 42 being approximately 0.5 mm thick adjacent the groove 39 containing the o-ring 40 and 2 mm thick elsewhere.

FIG. 2A illustrates the positions of the head 5 of the gas capsule 4 and the recess 34 for receiving the head 5 of the gas capsule 4 when the screw thread 28 on the exterior of the spacer element 20 is first engaged with the corresponding screw thread 30 on the interior of the wall 32 defining the recess 34 for receiving the head 5 of the gas capsule 4.

As can be seen from FIG. 2A, when the head 5 of the gas capsule 4 is initially engaged with the screw thread 30 on the interior of the wall 32 defining the recess 34, this causes the shaft 36 to be aligned with channel 25 in the centre of the spacer element 20. As can be seen the diameter of the channel 25 in the spacer element 20 is selected so as to be slightly larger than the diameter of the shaft 36 so that the shaft 36 can access the pierceable diaphragm 22 via the channel 25.

FIG. 2B illustrates the relative positions of the head 5 of the gas capsule 4 and the recess 34 as the screw thread is tightened. As the screw thread is tightened, the shaft 36 within the recess 34 is brought closer to the pierceable diaphragm 22 and caused to enter the channel 25 in the spacer element 20. As the diameter of the channel 25 is only slightly larger than the diameter of the shaft 36, when the shaft 36 enters the channel 25 as illustrated, this causes the o-ring 40 to become compressed between the walls of the channel 25 and the shaft 36. Thus at the point where the shaft 36 enters the channel 25, a seal is formed between the shaft and the walls of the channel 25. By ensuring that the distance between the groove 39 containing the o-ring 40 and the piercing tip 38 is less than the axial extent of the channel 25, the formation of this seal can be guaranteed to occur before the piercing tip 38 reaches the pierceable diaphragm 22.

FIG. 2C illustrates the relative positions of the head 5 of the gas capsule 4 and the recess 34 when the screw thread is fully tightened. In this position the shaft 36 extends along the entirety of the channel 25 which brings the piercing tip 38 into contact with the pierceable diaphragm 22, piercing the diaphragm 22 and causing gases contained within the capsule 4 to pass through to the valve 6 via the axial conduit 42 running through the centre of the shaft 36. When the capsule 4 and the recess 34 are in this position gases are prevented from exiting through the hole made in the pierceable diaphragm via any other route as the seal between the o-ring 40 carried on the shaft 36 and the walls of the channel 25 prevent gases from exiting via the channel 25 and the o-ring 26 between the spacer element 20 and the pierceable diaphragm 22 prevents gases from leaking between the pierceable diaphragm 22 and the spacer element 20.

FIG. 2D illustrates the relative positions of the head 5 of the gas capsule 4 and the recess 34 when the screw thread is partially released after having been fully tightened but before the gas capsule 4 is fully disengaged from the recess 34. As the screw thread is released, this causes the shaft 36 to withdraw from the channel 25. When the shaft 36 is withdrawn to the extent that the o-ring 40 carried on the shaft 36 is withdrawn from the channel 25, this causes the seal between the shaft 36 and the walls of the channel 25 to be broken. Gases from within the capsule can then pass through the channel 25 into the recess 34 and be vented via relief vents 44 in the walls 32 of the recess 34. Safety can be ensured by ensuring that the relief vents 44 are sufficient to vent the contents of a gas capsule 4 to a safe level in the time necessary to completely disengage the screw threads 28, 30 on the spacer element 20 and the wall 32 of the recess 34 to the extent necessary to remove the head 5 of the gas capsule 4 from the recess 34.

### SECOND EMBODIMENT

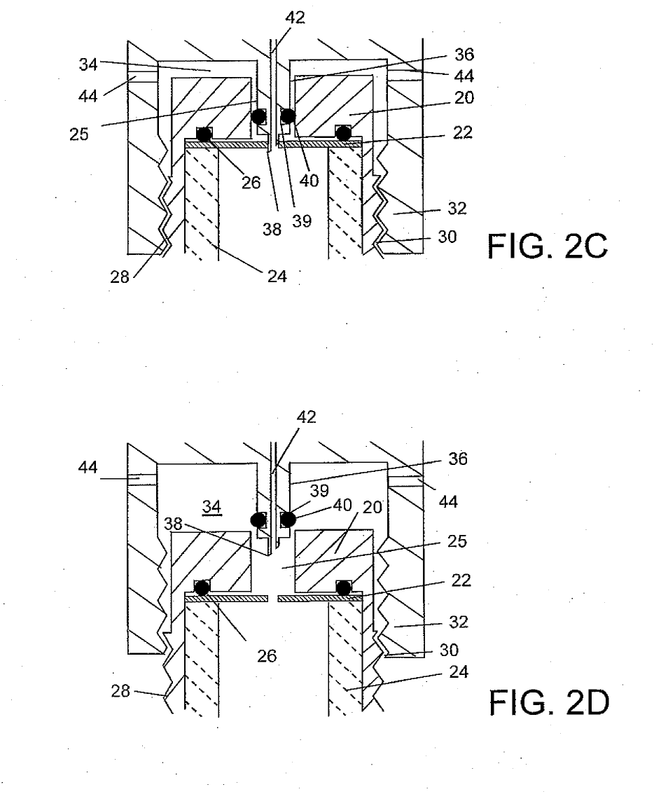

FIG. 3, illustrates a second embodiment of the present invention in which elements identical to the elements illustrated in FIGS. 2A-D are indicated with the reference numbers previously used.

In the previous embodiment a gas supply system was described in which the creation of a seal between a shaft 36 and a spacer element 20 was achieved via an o-ring 40 carried in a groove 39 in the shaft 36. In the previous embodiment, the creation of a seal, before the piercing of a pierceable diaphragm 22 was achieved by restricting access to the pierceable diaphragm 22 to a channel of approximately the same dimension as the shaft 36 where the length of the shaft was greater than the distance between the groove 39 carrying the o-ring 40 and the piercing tip 38 at the end of the shaft 36.

In contrast, in this embodiment, no o-ring 40 is carried on the shaft 36 which protrudes within the recess 34 for receiving the head 5 of a gas capsule 5. Instead, a groove 46 is provided within the wall of the channel 25 in the spacer element 20 and an o-ring 47 is carried within this groove with the groove 46 being separated from the portion of the spacer element 20 immediately adjacent the pierceable diaphragm 22.

As in the previous embodiment as the screw threads 28,30 on the spacer element 20 and the wall 32 defining the recess 34 engage, the shaft 36 protruding into the recess 34, is caused to enter into the channel 25 in the spacer element 20. When the shaft 36 reaches the o-ring 47 in the groove 46 in the wall of the channel 25, this causes the o-ring 47 to be compressed and form a seal against the outside of the shaft 36. As the groove 46 is separated from the pierceable diaphragm 22, this seal will be formed before the shaft reaches the pierceable diaphragm 22 and hence will be formed before the diaphragm 22 is broken.

In contrast to the first embodiment, as the o-ring 47 is carried within a groove 46 in the wall of the channel 25 rather than being carried in a groove 39, on the shaft 36, the diameter of the shaft 36 can be reduced compared with the diameter of the shaft 36 in the first embodiment. This is advantageous as reducing the diameter of the shaft 36 has the effect of reducing the force which arises when gases are released from the capsule 4 which act to lock the screw thread and prevent the capsule 4 from being further engaged into the recess 34 making it easier for a user to fully engage the capsule head 5 into the recess 34 in the valve 6.

Thus for example if a gas capsule 4 contains gas at pressure of 200 bar, a typical pressure for gas capsules, the effect of gas on the shaft depends upon the effective diameter of the shaft 36 as set out in the following table:

| | Force due to 200 bar |
|---|---|
| Sealing diameter (mm) | acting on diameter (N) |
| 2.5 | 98 |
| 3 | 141 |
| 4 | 251 |
| 5 | 393 |
| 6 | 565 |
| 7 | 770 |
| 8 | 1005 |
| 9 | 1272 |
| 10 | 1571 |
| 11 | 1901 |

In the case of the first embodiment, the effective diameter of the shaft 36 is the diameter of the shaft plus the extent of protrusion of the o-ring 40 mounted on the shaft 36. In contrast, in the present embodiment, the effective diameter is solely the diameter of the shaft 36 and the diameter of the shaft 36 itself can be made smaller as the shaft does not need to be designed to carry an o-ring.

Thus for example a shaft 36 with an axial conduit 42 having a diameter of approximately 1 mm and walls 0.75 mm thick the effective sealing area would be limited to an area of with a diameter of approximately 2.5 mm. In contrast a shaft 36 having a similar sized axial conduit 42 where the walls of the shaft 36 were sufficiently thick to allow for a groove 38 to carry an o-ring 40 such as was described in the first embodiment would have an effective sealing area having a diameter in excess of 5 mm.

As in the previous embodiment, if the gas capsule 4 is disengaged after the pierceable diaphragm 22 has been pierced the gases are vented out of the relief vents 44. In this embodiment, to assist with the venting of gases, an additional relief vent 50 is provided in the spacer element 20 communicating with the channel 25 in the spacer element 20 to a portion of the channel 25 on the opposite side of the groove 46 to the pierceable diaphragm 22. This relief vent provides an additional gas flow path from the channel 25 when a gas capsule 4 is being disengaged from the recess 34 and thereby assists in ensuring that a gases within a gas capsule 4 are vented to a safe level before the screw threads 28, 30 are fully disengaged and the gas capsule 4 can be removed from the recess 34

### THIRD EMBODIMENT

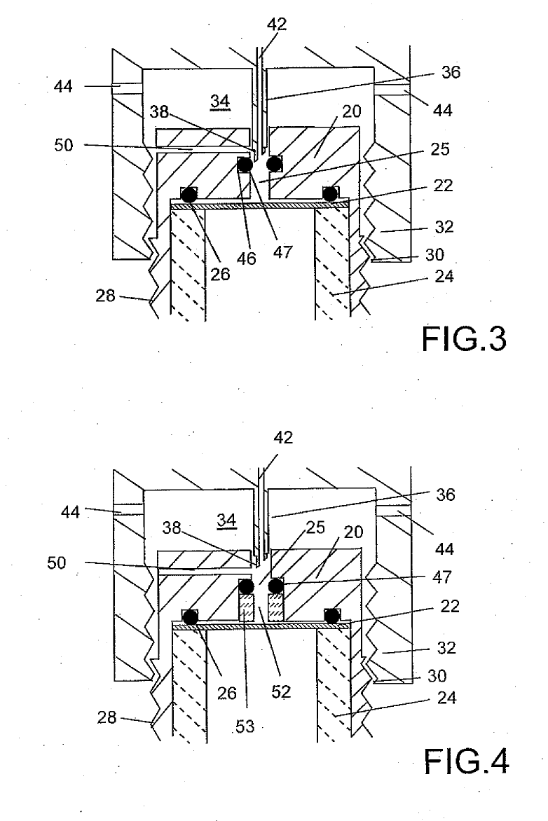

FIG. 4, illustrates a third embodiment of the present invention in which elements identical to the elements illustrated in FIG. 3 are indicated with the reference numbers previously used.

In the previous embodiment a spacer element 20 was described in which an o-ring 47 was carried in a groove 46 adjacent a channel 25 in the spacer element 20. In contrast with the spacer element 20 in the previous embodiment, in this embodiment, the channel 25 in the spacer element 20 communicates with a chamber 52 open at the surface adjacent the pierceable diaphragm 22. An o-ring 47 is then held in position within the chamber 52 adjacent the end of the channel 52 by a collar 53.

In the previous embodiment where an o-ring 47 is retained within a groove 46 in the walls of the channel, manufacturing a suitable groove 46 can be difficult where the diameter of the channel is small e.g. of the order of a few millimeters. The present embodiment avoids the difficulties of manufacturing a suitable groove within the channel by instead retaining the o-ring 47 within a larger chamber 52 using a collar 53.

In this embodiment, the collar 53 acts to hold o-ring 47 in a fixed position and separate the o-ring 47 adjacent the channel 25 from the pierceable diaphragm 22. Thus when the shaft 36 accesses the pierceable diaphragm 22 via the channel 25, the o-ring seals against the shaft 36 before the piercing tip 38 of the shaft 36 pierces the pierceable diaphragm 22.

### FOURTH EMBODIMENT

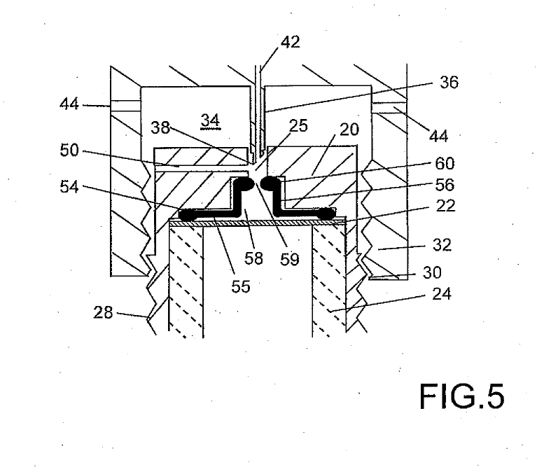

FIG. 5, illustrates a fourth embodiment of the present invention in which elements identical to the elements illustrated in FIG. 4 are indicated with the reference numbers previously used.

In the previous two embodiments, seals have been described as being formed using two o-rings 26, 47, one 47 adjacent a channel 25 in a spacer element 20 which forms against a shaft 36 and prevents gases from exiting via the channel 25, and another 26 forming a seal between the spacer element 20 and the head 5 of the gas capsule 4. In this embodiment, these o-rings are replaced with a single seal 54 comprising a disc 55 and a neck 56 which together have an L shaped cross section where the neck 56 extends away from the disc 55. A bead 57 is provided at the circumference of the disc 55. This seal 54 is then enclosed in a single cavity 58 provided in the spacer element 20 open adjacent the pierceable diaphragm 22 with the bead 57 at the periphery of the disc portion 55 of the seal 54 being compressed and sealing between the diaphragm 22 and the spacer element 20.

Where an o-ring 47 is contained within a groove 46 adjacent a channel 25 in the spacer element 20 or retained in place using a collar 53 there can be a tendency for gas pressure to try to eject the o-ring 47 on disconnection. In contrast in the present embodiment as the seal 54 is enclosed within the cavity 58 and the seal has an L shaped profile the seal 54 is prevented from being ejected as the seal 54 cannot pass through the channel 25 in the spacer element 20.

A hole 59 is provided in the centre of the seal 54 at the end of the neck 56 remote from the disc 55 where the edge of the hole 59 is surrounded by lip 60. The proportions of the hole 59 in the seal 54 are then such that when a shaft 36 accesses the pierceable diaphragm 22 via the channel 25, a seal is formed between the lip 60 and the shaft 36 as the shaft 36 enters the hole 59. The axial extent of the neck 56 acts to space the lip 60 which seals against the shaft 36 from the pierceable diaphragm 22 and hence ensures that this seal is formed prior to the piercing tip 38 of the shaft 36 piercing the diaphragm 22.

### FIFTH EMBODIMENT

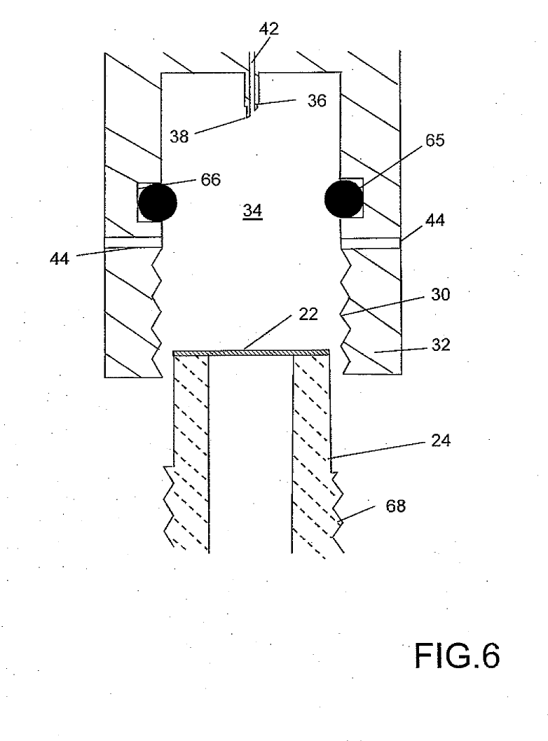

FIG. 6, illustrates a fifth embodiment of the present invention in which elements identical to the elements illustrated in FIG. 3 are indicated with the reference numbers previously used.

In this embodiment instead of an o-ring 47 being retained within a groove 46 within a spacer element 20, no spacer element 20 is provided. Rather an o-ring 65 is retained within a groove 66 within the wall 32 defining the recess 34 in the valve 6. The shaft 36 is then arranged to protrude into the recess 34 so that the tip 38 of the shaft 36 does not extend as far as the position of groove 66 in the wall 30 of the recess 34.

A screw thread 68 is provided on the exterior of the wall 24 of the head 5 of the gas capsule 4. When the screw thread 68 on the head 5 of the gas capsule 4 is engaged with the screw thread 30 on the wall 32 defining the recess, the relative positions of the o-ring 65 and the piercing tip 38 are such that the o-ring 65 forms between the exterior of the head 5 of the gas capsule 4 before the piercing tip 38 pierces the pierceable diaphragm 22.

When the piercing tip 38 pierces the pierceable diaphragm 22 gases will be released from the capsule 4. When this occurs, the pressure of gas released will act upon the interior of the recess 34 generating a force dependent upon the effective cross sectional area of the recess 34. For this reason in order to reduce this effective sealing area the diameter of the portion of head 5 of the capsule 4 which is arranged to fit into the recess should be minimized. This then enables the diameter of the recess 34 to be reduced.

### SIXTH EMBODIMENT

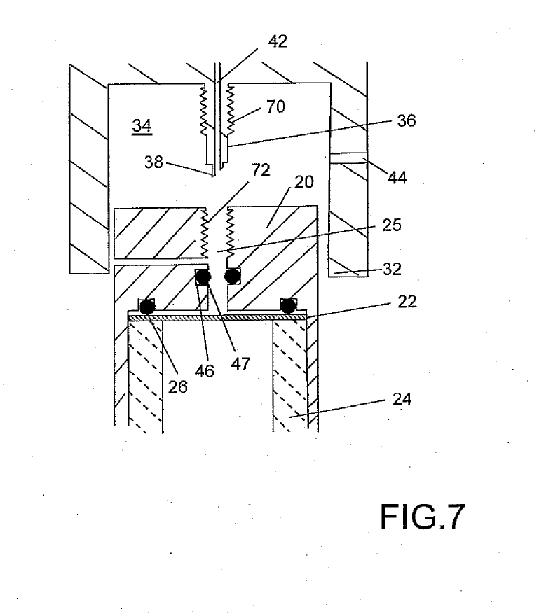

FIG. 7, illustrates a sixth embodiment of the present invention in which elements identical to the elements illustrated in FIG. 3 are indicated with the reference numbers previously used.

In this embodiment instead of screw threads 28, 30 being provided on the exterior of the spacer element 20 and the interior of the wall 32 defining the recess 34, screw threads 70, 72 are provided upper portion of the shaft 36 and the upper portion of the walls of the spacer element 20 defining the channel 25 for accessing the pierceable diaphragm 22. That is to say a screw thread 70 is provided on the exterior of the shaft 36 at the end of the shaft 36 remote from the piercing tip 38 and a corresponding screw thread 72 is provided on the wall of the channel 25 in the spacer element 20 at the end of the channel 25 remote from the pierceable diaphragm 22.

When the shaft 36 is caused to enter the channel 25, these two screw threads 70, 72 will engage enabling the tip 38 of the shaft 36 to access and pierce the pierceable diaphragm 22. By arranging for the screw threads 70 to be provided on the shaft 36 and on the walls of the channel rather than the exterior of the spacer element 20 and the interior of the wall 32 defining a recess 34, threads having a smaller diameter can be used. This then reduces the torque users must apply to the capsule 4 to cause the capsule 4 to engage in the recess 34.

It will be understood that the embodiments described herein are merely exemplary and that one skilled in the art may make variations and modifications without departing from the spirit and scope of the present invention. All such variations and modifications are intended to be included within the scope of the invention as described above. Further, all embodiments disclosed are not necessarily in the alternative, as various embodiments of the invention may be combined to provide the desired result.

What is claimed is:

1. A gas supply system comprising:
a gas capsule enclosed at one end by a pierceable diaphragm;
a spacer element adjacent the pierceable diaphragm, the spacer element having a channel providing access to the pierceable diaphragm;
a shaft with a piercing tip; and
a seal,
wherein the shaft, spacer element and seal are arranged so that when the shaft accesses the pierceable diaphragm via the channel, the shaft is caused to enter into a sealing engagement with the spacer element via the seal before the piercing tip pierces the pierceable diaphragm.

2. A gas supply system in accordance with claim 1 wherein the seal is carried on the shaft at a position where the distance between the seal and the piercing tip is less than the length of the channel.

3. A gas supply system in accordance with claim 1 wherein the seal is provided in a recess adjacent the channel where a portion of the seal protrudes into the channel at a position spaced from the pierceable diaphragm.

4. A gas supply system in accordance with claim 3 wherein a vent communicating with the channel is provided within the spacer element adjacent the end of the channel remote from the pierceable diaphragm, the recess being provided at a position between the pierceable diaphragm and the vent.

5. A gas supply system in accordance with claim 3 wherein the recess is open at a surface adjacent the pierceable diaphragm and the seal is held within the recess between the spacer element and a collar provided in the recess, the collar acting to space the seal from the pierceable diaphragm.

6. A gas supply system in accordance with claim 3, further comprising a further seal provided within a groove in the spacer element adjacent the pierceable diaphragm wherein the spacer element is in a sealing engagement with the gas capsule via the further seal.

7. A gas supply system in accordance with claim 3 wherein a portion of the seal remote from the portion of the seal protruding into the channel is in a sealing engagement with the pierceable diaphragm and the spacer element.

8. A gas supply system in accordance with claim 1 wherein a screw thread is provided on a portion of the exterior of the shaft remote from the piercing tip and a complementary screw thread is provided on a portion of the interior of the channel remote from the pierceable diaphragm.

9. A gas supply system comprising:
a wall defining a recess for receiving the end of a gas capsule enclosed by a pierceable diaphragm;
a shaft with a piercing tip protruding into the recess; and
a seal provided in the wall and protruding into the recess;
wherein the seal is located at a position in the wall so that when a gas capsule is inserted into the recess, the seal enters into a sealing engagement with the gas capsule before the piercing tip of the shaft pierces the pierceable diaphragm enclosing the gas capsule.

10. A gas supply system in accordance with claim 9 further comprising:
a housing defining a docking station for receiving a gas capsule;
a gas pressure control valve arranged to receive gas from a gas capsule inserted in the docking station and pass gas to an output.

11. A gas capsule comprising:
a housing defining a cavity for containing gas, the cavity being enclosed at one end by a pierceable diaphragm;
a spacer element adjacent the pierceable diaphragm, the spacer element having a channel providing access to the pierceable diaphragm, the channel being configured to receive a shaft terminating with a piercing tip for piercing the pierceable diaphragm, and
a seal provided in a recess in the spacer element adjacent the channel, wherein the arrangement of the channel and the seal is such that when a shaft terminating with a piercing tip for piercing the pierceable diaphragm accesses the pierceable diaphragm via the channel, the shaft is caused to enter into a sealing engagement with the spacer element via the seal before the piercing tip pierces the pierceable diaphragm.

12. A gas capsule in accordance with claims 11 wherein a vent communicating with the channel is provided within the spacer element adjacent the end of the channel remote from the pierceable diaphragm, the recess being provided at a position between the pierceable diaphragm and the vent.

13. A gas capsule in accordance with claim 11 wherein the recess in the spacer element is open at a surface adjacent the pierceable diaphragm and the seal is held within the recess between the spacer element and a collar provided in the recess, the collar acting to space the seal from the pierceable diaphragm.

14. A gas capsule in accordance with claim 11, further comprising a further seal provided within a grove in the spacer element adjacent the pierceable diaphragm wherein the spacer element is in a sealing engagement with the housing via the further seal.

15. A gas capsule in accordance with claim 11 wherein a portion of the seal protrudes into the channel wherein the spacer element is in a sealing engagement with the housing via a portion of the seal remote from the portion of the seal protruding into the channel.

16. A gas supply apparatus comprising:
a housing defining a docking station for receiving a gas capsule enclosed at one end by a pierceable diaphragm, having a spacer element adjacent the pierceable diaphragm, the spacer element having a channel providing access to the pierceable diaphragm and a seal in a recess in the spacer element adjacent the channel; and
a shaft terminating in a piercing tip arranged relative to the housing so that when the docking station receives a gas capsule, the shaft is caused to access the pierceable diaphragm of the gas capsule via the channel in the spacer element of the gas capsule, with the shaft entering into a sealing engagement with the spacer element via the seal before the piercing tip pierces the pierceable diaphragm.

17. A gas supply apparatus is accordance with claim 16 wherein a screw thread is provided on the exterior of the shaft remote from the piercing tip the screw thread being operable to engage a complementary screw thread provided in the spacer element of a gas capsule received by the docking station.

18. A gas supply apparatus comprising:
a housing defining a docking station for receiving a gas capsule enclosed at one end by a pierceable diaphragm, having a spacer element adjacent the pierceable diaphragm, the spacer element having a channel providing access to the pierceable diaphragm; and
a shaft carrying a seal and terminating in a piecing tip, the shaft being arranged relative to the housing so that when the docking station receives a gas capsule, the shaft is caused to access the pierceable diaphragm of the gas capsule via the channel in the spacer element, with the shaft entering into a sealing engagement with the spacer element via the seal before the piercing tip pierces the pierceable diaphragm.

19. A gas supply apparatus in accordance with claim 18 further comprising a gas pressure control valve arranged to receive gas from a gas capsule inserted in the docking station and pass gas to an output.

20. A gas capsule comprising:
a housing defining a cavity for containing gas, the cavity being enclosed at one end by a pierceable diaphragm; and
a spacer element adjacent the pierceable diaphragm, the spacer element having a channel providing access to the pierceable diaphragm, the channel being configured to receive a shaft terminating with a piercing tip for piercing the pierceable diaphragm, wherein the shaft is caused to enter into a sealing engagement with the spacer element via the seal before the piercing tip pierces the pierceable diaphragm.

21. A gas capsule in accordance with claim 20 further comprising a seal provided within a groove in the spacer element adjacent the pierceable diaphragm wherein the spacer element is in a sealing engagement with the housing via the seal.
